(19) United States
(12) Patent Application Publication
(10) Pub. No.: US 2024/0018947 A1
(43) Pub. Date: Jan. 18, 2024

(54) GRAVITATIONAL POTENTIAL ENERGY CONVERTING DEVICE

(71) Applicants: TUEN-KEUI TSAI, Hualien County (TW); MEI-HUI WANG, Hualien County (TW); CIAN-KUAN CAI, Hualien County (TW)

(72) Inventors: TUEN-KEUI TSAI, Hualien County (TW); MEI-HUI WANG, Hualien County (TW); CIAN-KUAN CAI, Hualien County (TW)

(21) Appl. No.: 17/865,439

(22) Filed: Jul. 15, 2022

(51) Int. Cl. F03G 3/00

(52) U.S. Cl. CPC F03G 3/00

(57) ABSTRACT

A gravitational energy conversion device is configured to rotate or translate on a support surface. The gravitational energy conversion device has a weight and multiple energy converters; the energy converters are mounted around an exterior of the weight and disposed apart from each other. When the weight rotates or translates to make the energy converters contact the support surface, the weight presses down the energy converters due to gravity. When the weight rotates or translates to make the energy converters separate from the support surface, energy in the energy converters is released and transformed into kinetic energy of the weight. Therefore, the device is effective in energy-saving and cushioning.

### BACKGROUND OF THE INVENTION

### 1. Field of the Invention

The present invention relates to a device for converting potential energy associated with gravity (Earth's gravity, for example) to another form of energy such as kinetic energy, elastic potential energy, or electric potential energy.

### 2. Description of the Prior Arts

Any object on a planet is subjected to effect of Earth's gravity, and gravitational force always exits. Take Earth for example, gravitational acceleration near Earth's surface is 9.80665 m/s2; at this acceleration, speed of a free-falling object exceeds 100 KM/H within 2 seconds; if gravitational energy can be made used of, it would become a tremendous source of energy.

All kinds of rotational parts in the existing technology inevitably bounce up and down. However, it is a great pity that kinetic energy associated with bouncing up and down, which is originated from gravitational potential energy, can only be converted into heat instead of being recycled for further use.

Moreover, existing electrical generators using gravitational force need to generate electricity via some natural medium; for example, to generate electricity from hydropower requires building a dam in a proper location, and then electricity can be generated using potential energy from water; it is troublesome to generate electricity using gravitational energy.

### SUMMARY OF THE INVENTION

In view of the drawbacks and deficiencies of the aforementioned prior art, the present creation provides a gravitational energy conversion device and system to recycle kinetic energy of all kinds of rotational parts associated with bouncing up and down.

To achieve the above mentioned purpose of creation, the technical means employed by the present creation is to design a gravitational energy conversion device configured to rotate or translate on a support surface; the gravitational energy conversion device comprises a weight and multiple energy converters; the energy converters are mounted around an exterior of the weight and disposed apart from each other. When the weight rotates or translates to make the energy converters contact the support surface, the weight presses down the energy converters due to gravity; when the weight rotates or translates to make the energy converters separate from the support surface, energy in the energy converters is released and transformed into kinetic energy of the weight.

To achieve the above mentioned purpose of creation, the present creation further provides a gravitational energy conversion system, comprising a flat conveyor and a gravitational energy conversion device as mentioned above. The flat conveyor is configured to convey along a conveying direction; the support surface is an upper surface of the flat conveyor, and a center line of the gravitational energy conversion device is perpendicular to the conveying direction of the flat conveyor. When the gravitational energy conversion device rotates on the support surface, the flat conveyor is capable of conveying the gravitational energy conversion device along the conveying direction to keep a position of the gravitational energy conversion device on the flat conveyor.

To achieve the above mentioned purpose of creation, the present creation further provides a gravitational energy conversion system, comprising a second base, a support roller, and the gravitational energy conversion device as mentioned above. An axle of the support roller is fixed to the second base. The support surface of the gravitational energy conversion device is an outer annular surface of the support roller, and a center line of the gravitational energy conversion device is parallel to the axle of the support roller.

The advantage of the present invention is capable of recycling kinetic energy of all kinds of rotational parts associated with bouncing up and down, and is effective in energy-saving and cushioning.

Furthermore, when an object touches the ground, it is subjected to the reaction force of the gravitational force; Newton's law: force equals reaction force; we can think of a way to change the direction of reaction force since we are unable to change the direction of the gravitational force. The reaction force of the gravitational force (gravity) can become the energy that makes the object move, wherein MG=MA.

Reaction force of gravitational force is directed upward, and there needs to be a way to change the direction of said reaction force. The reaction force changes only at the moment that an object touches the ground. Assistance provided by transformation is limited even when all are transformed in one time. The reaction force can be obtained by letting an object rotate and keep renewing contact points with the ground so that there are the reaction forces. A combination like this will have the reaction force for transformation, and utilizing rotation and translation of a circle is the most power-saving method.

### BRIEF DESCRIPTION OF THE DRAWINGS

FIG. 1 is a schematic side view of a first embodiment of a gravitational energy conversion device in accordance with the present invention;

FIG. 2 is a schematic side view of a second embodiment of a gravitational energy conversion device in accordance with the present invention;

FIG. 3 a schematic sectional view of an energy converter of the gravitational energy conversion device in FIG. 2;

FIG. 4 is a schematic sectional view of a third embodiment of a gravitational energy conversion device in accordance with the present invention;

FIG. 5 a schematic sectional view of the energy converter of the gravitational energy conversion device in FIG. 4;

FIG. 6 is a schematic side view of a first embodiment of a gravitational energy conversion system in accordance with the present invention;

FIG. 7 is a schematic side view of a second embodiment of a gravitational energy conversion system in accordance with the present invention;

FIG. 8 is a schematic operational view of a fourth embodiment of a gravitational energy conversion device in accordance with the present invention;

FIG. 9 is a schematic side view of a third embodiment of a gravitational energy conversion system in accordance with the present invention.

### DETAILED DESCRIPTION OF THE PREFERRED EMBODIMENTS

There are two methods which are capable of transmitting driving force and changing direction of force at the same time, and all said methods can be configured to be installed on the cylindrical weight. The first is mechanical type: constituted by adding curved spring plates or curved steel plates together with helical springs. Second, hydraulic type: install a reciprocating pump which generates pressure, and then use the pressure to drive the cylinder via a turbine. The two methods are all capable of transmitting and changing the direction of the reaction force of the gravitational force.

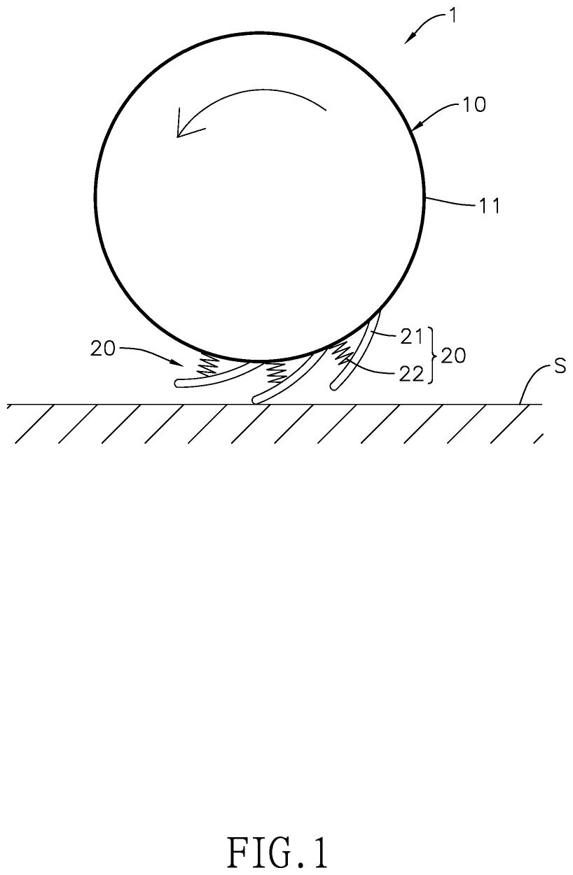

With reference to FIG. 1, a first embodiment of the gravitational energy conversion device 1 in accordance with the present invention is configured to rotate on a support surface S, and the support surface S is preferably a flat surface being horizontal. The gravitational energy conversion device 1 has a weight 10 and multiple energy converters 20. The weight 10 is cylindrical, and the energy converters 20 are mounted around an outer annular surface 11 of the weight and disposed apart from each other.

Each of the energy converters 20 has a moving part 21 and a resilient part 22. The moving part 21 protrudes from the outer annular surface 11 of the weight 10, and is movable toward or away from the weight 10. The moving part 21 is preferably a flat spring; an end of the moving part 21 is mounted to the weight; another end of the moving part 21 protrudes from the outer annular surface 11 of the weight 10 and is movable toward or away from the weight 10. The resilient part 22 is mounted between the moving part 21 and the weight 10, and drives the moving part 21 to move away from the weight 10.

When the weight 10 rotates to make the energy converter 20 contact the support surface S, the weight 10 presses down the energy converter due to gravity to move the moving part 21 toward the weight 10, thereby increasing elastic potential energy stored in the resilient part 20. When the weight 10 rotates to separate the energy converter 20 from the support surface S, the resilient part 20 drives the moving part 21 to move away from the weight 10 such that the elastic potential energy stored in the resilient part 20 is transformed to the kinetic energy of the weight 10.

In the preferred embodiment, each resilient part 22 is a helical spring (a.k.a. coil spring), but not limited thereto. Each resilient part 22 could be a gas spring, or a magnetic spring as long as the resilient part 22 is capable of storing elastic potential energy. Moreover, when the moving part 21 itself is made of resilient materials and capable of storing elastic potential energy, the resilient part 22 can be omitted depending on the condition.

An advantage of the above-mentioned first embodiment is that utilizing rolling of the cylindrical weight 10 to move forward saves effort, and the rolling generates new reaction forces with respect to the ground. The reaction forces from the ground are at contact points, and the reaction force of the gravitational force is directed upward.

When designing the above mentioned first embodiment, it is necessary to have a precise calculation of weight of the weight 10, and fit with proper amount of the resilient parts 22 which have proper elastic forces. When the weight 10 rolls to move forward, the weight 10 presses against the resilient parts 22, and then the resilient parts 22 bounce back after the resilient parts 22 pass through the support surface S. Each force generated when the resilient parts 22 bounce back equals two component forces: first, one of the component forces directed upward to cancel the gravitational force. Second, another one of the horizontal component forces drives the weight 10 to rotate.

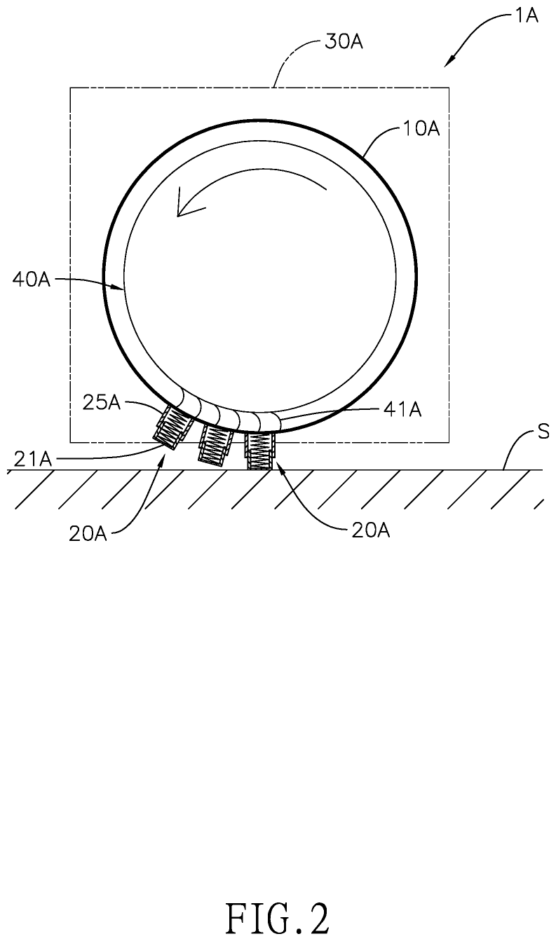

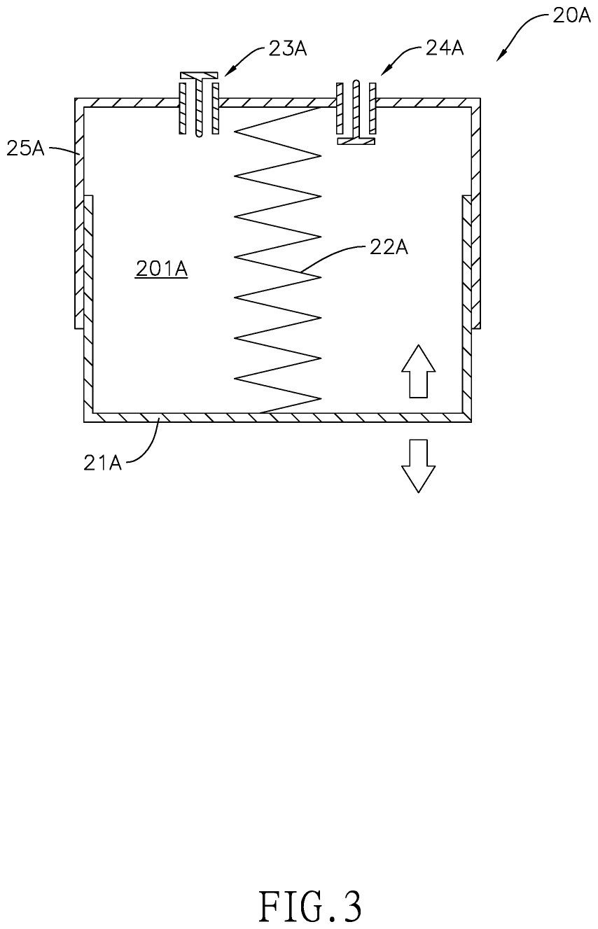

With reference to FIG. 2 and FIG. 3, the gravitational energy conversion device 1A in a second embodiment is substantially same as the first embodiment, but the difference is that the energy converters 20A in the second embodiment further comprises a fluid mechanism.

To be specific, the second embodiment further has a first base 30A and a fluid actuator 40A in comparison with the first embodiment. The weight 10A is rotatably mounted on the first base 30A. The fluid actuator 40A is mounted between the first base 30A and the weight 10A. The fluid actuator 40A is preferably a turbine having multiple blades 41A.

Each of the energy converters 20A further has an output check valve 23A, an input check valve 24A, and a fixed part 25A. The fixed part 25A is fixed to the weight 10A, and the moving part 21A is movably connected to the fixed part 25A; a fluid chamber 201A is formed between the fixed part 25A and the moving part 21 A; two ends of the output check valve 23A are connected to the fluid chamber 201A and the fluid actuator 40A respectively; two ends of the input check valve 24A are connected to the fluid chamber 201A and the fluid actuator 40A respectively.

When the energy converter 20 is pressed down by the weight 10A due to gravity and makes the moving part 21A move toward the weight 10A, the moving part 21A drives fluid in the fluid chamber 201A to flow into the fluid actuator 40A via the output check valve 23A. Kinetic energy of said fluid is transferred to the fluid actuator 40A (turbine) via the blades 23A, and therefore makes the fluid actuator 40A drive the weight 10A to rotate. When the moving part 21A moves away from the weight 10A, the moving part 10A drives fluid in the fluid actuator 40A to flow into the fluid chamber 201A via the input check valve 24A. The fluid is preferably liquid.

In other words, the second embodiment is to mount reciprocating pumps around a periphery of the weight 10 A, and each pump has a one-way valve mounted on each entrance and exit of said pump such that the entrance allows only entrance but not exit and that the exit allows only exit but not entrance. Utilizing pneumatic/hydraulic pressure to transfer power makes redirection of the reaction force of gravitational force easier. Use gravitational force to press the pumps, causing pressure to build up in the liquid inside the pump and forcing the liquid to rush out, and then guide the liquid into turbine to push the weight 10A to rotate. When the gravitational force is moved away, use the resilient part 22 A to bounce back, and use suction force at this moment to replenish the fluid.

Power is transferred via gas pressure or liquid pressure. Gas is compressible and therefore more difficult to use, and liquid pressure is mainly used. However, when air is used as a medium, recycling system can be omitted, and benefits heat dissipation.

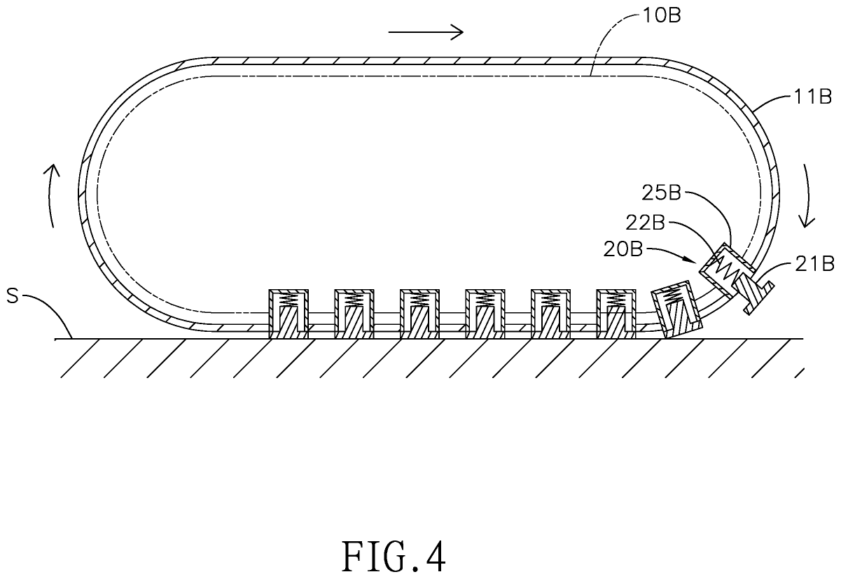

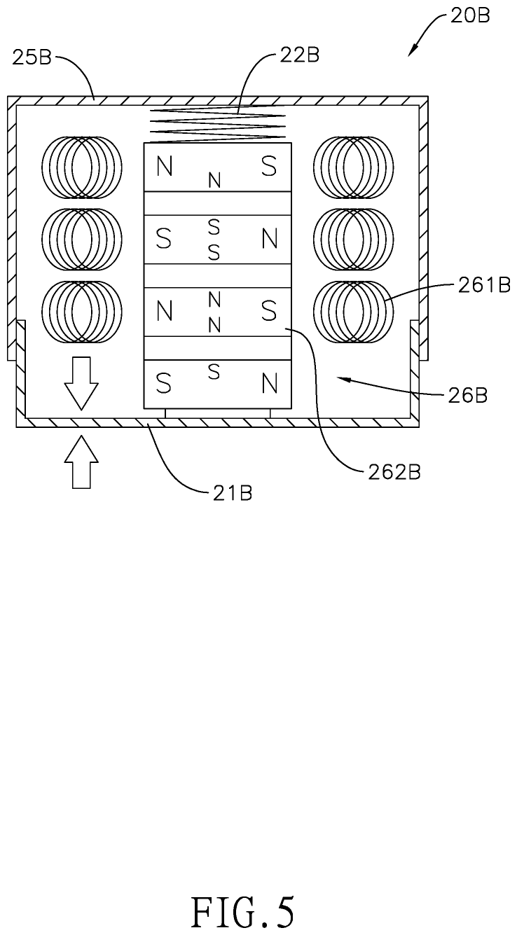

With reference to FIG. 4 and FIG. 5, a third embodiment of the gravitational energy conversion system differs from the first embodiment in that the weight 10B itself does not rotate, instead a caterpillar 11B is located around the weight 10B and allows the weight 10B to translate on the support surface S.

To be specific, the caterpillar 11B is located around the weight 10B and capable of revolving around the weight 10B. The caterpillar 11B is configured to drive the weight 10B to translate on the support surface S.

The energy converters 20B are disposed apart from each other on the caterpillar 11B; the moving part 21B of each of the energy converter 20B protrudes from an outer surface of the caterpillar 11B, and is movable toward or away from the weight 10B. The resilient part 22B (as shown in FIG. 5) is mounted between the moving part 21B and the caterpillar 11B, and drives the moving part 21B to move away from the weight 10B. To be precise, the fixed part 25B of the energy converter 20B is mounted on the caterpillar 11B; one end of the resilient part 22B abuts against the moving part 21B, and another end of the resilient part 22 abuts against the fixed part 25B such that the resilient part 22B is mounted between the caterpillar 11B and the moving part 21B.

When the caterpillar 11B revolves around the weight 10B to make the energy converters 20B contact the support surface S, the weight 10B presses down the energy converters 20B due to gravity to move the moving part 21B toward the weight 10B, thereby increasing elastic potential energy stored in the resilient part 22B. When the caterpillar 11B moves to separate the energy converters 20B from the support surface S, the resilient part drives 22B the moving part 21B to move away from the weight 10B such that the elastic potential energy stored in the resilient part 22B is transformed to the kinetic energy of the weight 10B.

Moreover, the energy converter 20B in the third embodiment further has a linear electrical generator 26B mounted therein; principle of the linear electrical generator 26B is the same as that of traditional rotary electrical generators, and only replaces rotary motion with reciprocating motion. The linear electrical generator 26B has generating coils 261B and permanent magnets 262B; the generating coils 261B are mounted to the fixed part 25B, and the permanent magnets 262B are mounted to the moving part 21B. When the moving part 21B moves, the permanent magnets 262B move relative to the generating coil 261B such that the linear electrical generator 26B generates electricity. The linear electrical generator 26B can be replaced by piezoelectric device depending on the condition.

In the third embodiment, proper amount of the linear electrical generators 26B are mounted on a periphery of the weight 10B. The linear electrical generators 26B are pressed by the reaction force of the gravitational force, and a coil spring, a magnetic spring, or a gas spring is mounted on another side of the linear electrical generators 26B for bouncing back; the resilient part 22B could be omitted and using centrifugal force for throwing out; generated electric power is provided to a motor to rotate the weight 10B. After started, press the linear electrical generators 26B one after another, and electric power is generated in each reciprocate stroke, thereby greatly reducing consumption of electric power of the motor.

Power-generating-capacity of each linear electrical generator 26B can be controlled by an armature as the conventional electric power generators. In another preferred embodiment, permanent magnets can be stringed together to form a center axle, and the generating coils 261B are fixed to the fixed part; in still another preferred embodiment, reciprocating motion of the generating coils 261B can be fixed by a permanent magnet array; or Halbach array can be considered for increasing a number of lines of magnetic flux. The linear electrical generators can be replaced by piezoelectric device for sure, but power is still too little, and will be a possible solution when there is a technical breakthrough.

To save space of the gravitational energy conversion device 1, the weight 10 can be lengthened such that more of the energy converters 20 can be mounted.

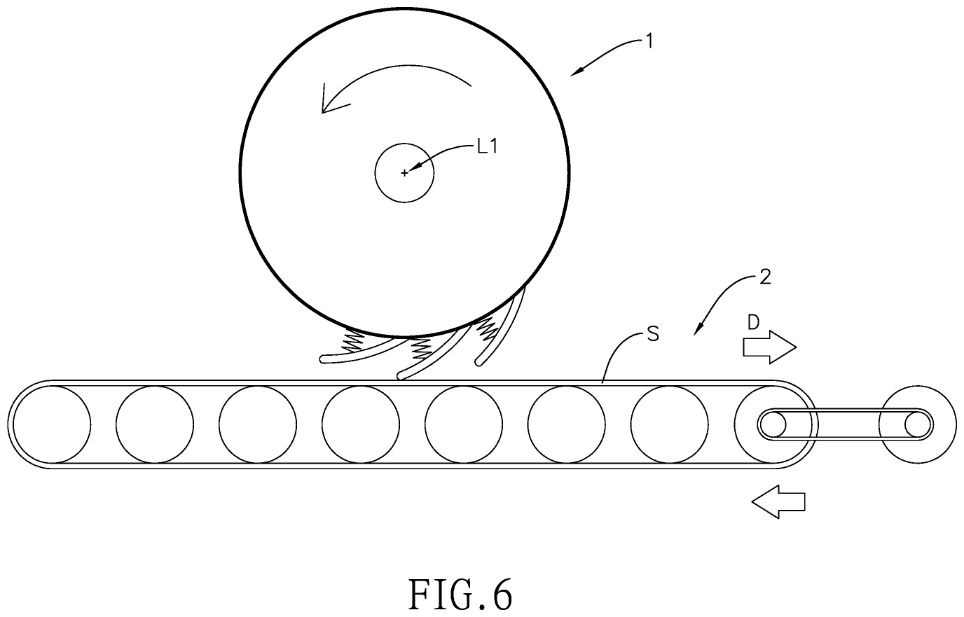

cushion device energy cushion system[0040] With reference to FIG. 1 and FIG. 6, a first embodiment of the gravitational energy conversion system comprises a flat conveyor 2 which is configured to convey external objects along a conveying direction D. A gravitational energy conversion device 1 as mentioned above in the first embodiment of the gravitational energy conversion device is mounted on an upper surface of the flat conveyor 2; that is, the upper surface of the flat conveyor 2 is the support surface S of the gravitational energy conversion device 1. An center line L 1 of the gravitational energy conversion device 1 is perpendicular to the conveying direction D of the flat conveyor 2, and therefore when the gravitational energy conversion device 1 rotates on the support surface S, the flat conveyor 2 is capable of conveying the gravitational energy conversion device 1 along the conveying direction D to keep a position of the gravitational energy conversion device 1 on the flat conveyor 2, thereby the gravitational energy conversion device 1 can rotate in space.

Second, free rollers having fixed axles: dispose the weight 10 in the middle of two of the free rollers (a.k.a. support rollers 4 as mentioned below) having fixed axles; rotation only drives the free rollers to rotate. The cylindrical body will escape without a critical rotational speed, and kinetic energy should be extracted before reaching rotational speed of escape.

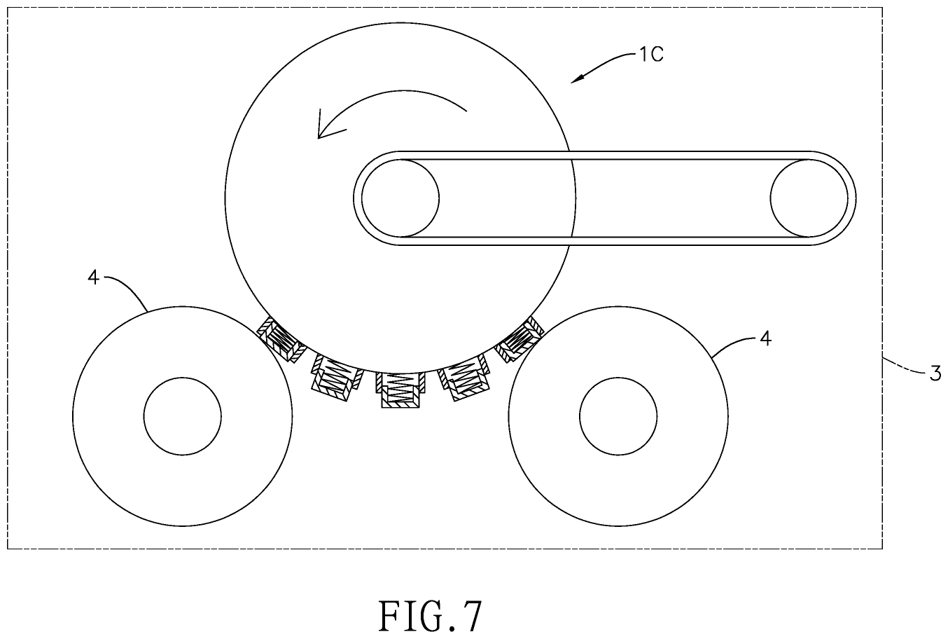

With reference to FIG. 7, a second embodiment of the gravitational energy conversion system has a second base 3, at least one support roller 4, and the gravitational energy conversion device 1C. An axle of the at least one support roller 4 is fixed to the second base 3; the support roller 4 is configured to rotate freely with the axle as a rotating axis.

In the preferred embodiment, the support surface of the gravitational energy conversion device 1C is an outer annular surface of the support roller 4, and a center line of the gravitational energy conversion device 1C is parallel to the axle of the support roller 4 such that the gravitational energy conversion device 1C can rotate in space.

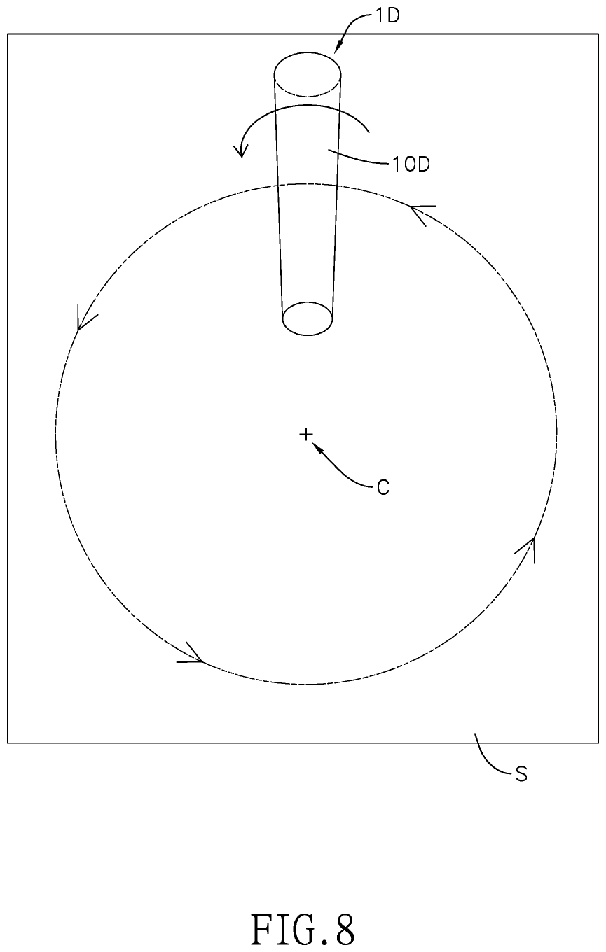

With reference to FIG. 8, a fourth embodiment of the gravitational energy conversion device is substantially same as the aforementioned gravitational energy conversion device, but the difference is that the weight 10D of the gravitational energy conversion device 1D in the fourth embodiment is conical in shape such that the weight 10D revolves around a center point C on the support surface S when rotating. Energy should be extracted before the weight 10D is thrown away due to centrifugal force under high speed.

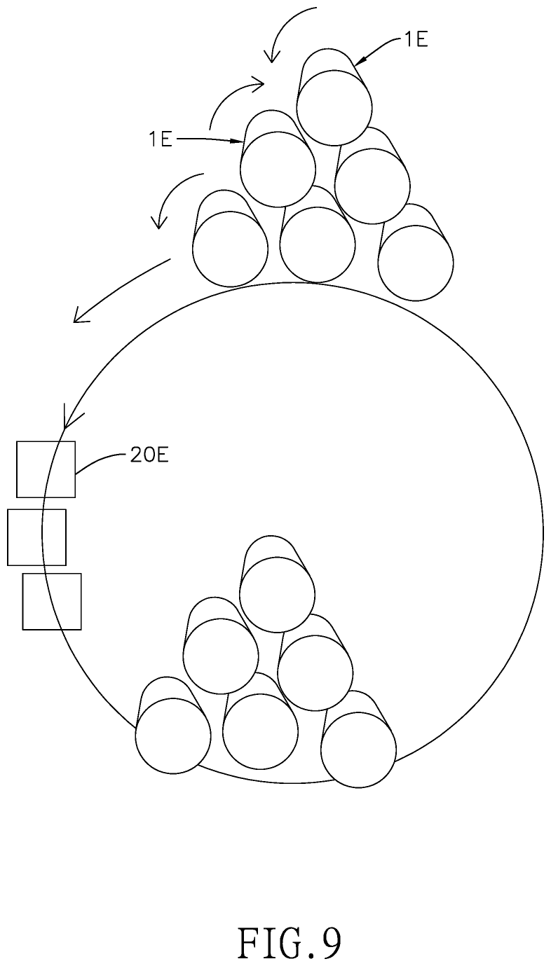

With reference to FIG. 9, another way is to have multiple sets of the gravitational energy conversion device 1E stacked on a loop mechanism; the device can also be stacked up to form multiple layers, and any two adjacent layers will rotate in reverse directions. The support roller with the fixed axle requires additional support rollers with the fixed axle on the plane. Finally, the gravitational force also acts on the loop mechanism; the reaction force of the gravitational force is capable of doing work, and the gravitational force is capable of doing work as well; to mount the device that converts reaction force of gravitational force on the ground makes the device become a device for converting gravitational force. As a result, the energy converters 20E should be mounted on the loop mechanism, and it will be easier to improve all gravitational force converting rates.

For the electrical type, the rotating speed can be controlled directly by the motor, and energy can be extracted when electricity generated is greater than electricity consumed by the motor.

For free rollers with fixed axles, multiple sets of the free roller with the fixed axle need to be added on the plane. Finally, the gravitational force also acts on the loop mechanism; the reaction force of the gravitational force is capable of doing work, and the gravitational force is capable of doing work as well; to mount the device that converts reaction force of gravitational force on the ground makes the device become a device for converting gravitational force. Therefore, the device or converting gravitational force should be mounted on the loop mechanism, and it will be easier to improve all the gravitational force converting rates.

In summary, force and energy do not occur out of nowhere. Assuming that the system is mounted along the east-westward direction on earth, revolution speed of earth will speed up or slow down as a result. It is believed that all motions on earth such as tide, wind, and even a step of us all affect the revolution speed of earth, but energy affected is too little to be accounted for.

What is claimed is:

1. A gravitational energy conversion device, configured to rotate or translate on a support surface, the gravitational energy conversion device comprising:
a weight; and
multiple energy converters mounted around an exterior of the weight and disposed apart from each other;
wherein when the weight rotates or translates to make the energy converters contact the support surface, the weight presses down the energy converters due to gravity; when the weight rotates or translates to make the energy converters separate from the support surface, energy in the energy converters is released and transformed into kinetic energy of the weight.

2. The gravitational energy conversion device as claimed in claim 1, wherein
the gravitational energy conversion device is configured to rotate on the support surface;
the weight is cylindrical;
the energy converters are mounted on an outer annular surface of the weight; each of the energy converters has
a moving part protruding from the outer annular surface of the weight and being movable toward or away from the weight; and
a resilient part mounted between the moving part and the weight and driving the moving part to move away from the weight;
wherein when the weight rotates to make the energy converter contact the support surface, the weight presses down the energy converter due to gravity to move the moving part toward the weight, thereby increasing elastic potential energy stored in the resilient part;
wherein when the weight rotates to separate the energy converter from the support surface, the resilient part drives the moving part to move away from the weight such that the elastic potential energy stored in the resilient part is transformed to the kinetic energy of the weight.

3. The gravitational energy conversion device as claimed in claim 2, wherein the moving part of each of the energy converters is a flat spring; an end of said moving part is mounted to the weight; another end of the moving part protrudes from the outer annular surface of the weight and is movable toward or away from the weight.

4. The gravitational energy conversion device as claimed in claim 2, wherein
the gravitational energy conversion device has a first base and a fluid actuator;
the weight is rotatably mounted on the first base; the fluid actuator is mounted between the first base and the weight;
each of the energy converters has a fluid chamber, and has
an output check valve; two ends of the output check valve connected to the fluid chamber and the fluid actuator respectively;
an input check valve; two ends of the input check valve connected to the fluid chamber and the fluid actuator respectively;
wherein, when the energy converter is pressed down by the weight due to gravity and makes the moving part move toward the weight, the moving part drives fluid in the fluid chamber to flow into the fluid actuator via the output check valve, and therefore makes the fluid actuator to drive the weight to rotate; when the moving part moves away from the weight, the moving part drives the fluid in the fluid actuator to flow into the fluid chamber via the input check valve.

5. The gravitational energy conversion device as claimed in claim 2, wherein each of the energy converters has a linear electrical generator mounted in said energy converter; two ends of the linear electrical generator are mounted to the weight and the moving part of the energy converter respectively; when the moving part is moved, the linear electrical generator generates electricity.

6. The gravitational energy conversion device as claimed in claim 1, wherein
the gravitational energy conversion device is configured to translate on a support surface;
the gravitational energy conversion device has a caterpillar located around the weight and capable of revolving around the weight; the caterpillar is configured to drive the weight to translate on the support surface;
the energy converters are disposed apart from each other on the caterpillar; each of the energy converter has
a moving part protruding from an outer surface of the caterpillar and being movable toward or away from the weight;
a resilient part mounted between the moving part and the caterpillar, and driving the moving part to move away from the weight;
wherein, when the caterpillar moves to make the energy converter contact the support surface, the weight presses down the energy converter due to gravity to move the moving part toward the weight, thereby increasing elastic potential energy stored in the resilient part;
wherein, when the caterpillar moves to make the energy converter separate from the support surface, the resilient part drives the moving part to move away from the weight such that the elastic potential energy stored in the resilient part is transformed to the kinetic energy of the weight.

7. The gravitational energy conversion device as claimed in claim 1, wherein each of the energy converters is a flat spring; an end of the energy converter protrudes from an outer surface of the weight, and is movable toward or away from the weight.

8. The gravitational energy conversion device as claimed in claim 1, wherein
each of the energy converters has
a moving part protruding from an outer surface of the weight, and being movable toward or away from the weight;
a linear electrical generator, two ends of the linear electrical generator are mounted to the weight and the moving part of the energy converter respectively; when the moving part is moved, the linear electrical generator generates electricity;
wherein, when the weight rotates to make the energy converter contact the support surface, the weight presses down the energy converter due to gravity to move the moving part toward the weight to make the linear electrical generator generate electricity;
wherein, when the weight rotates to separate the energy converter from the support surface, centrifugal force due to rotation of the weight makes the moving part to move away from the weight.

9. The gravitational energy conversion device as claimed in claim 1, wherein
the weight is conical in shape such that the weight revolves around a center point on the support surface when rotating on the support surface;
the energy converters are disposed on an outer annular surface of the weight; each of the energy converters has:
a moving part protruding from the outer annular surface of the weight, and being movable toward or away from the weight;
a resilient part mounted between the moving part and the weight, and driving the moving part to move away from the weight;
wherein, when the weight rotates to make the energy converter contact the support surface, the weight presses down the energy converter due to gravity to move the moving part toward the weight, thereby increasing elastic potential energy stored in the resilient part;
wherein, when the weight rotates to separate the energy converters from the support surface, energy in the energy converters is released and transformed into kinetic energy of the weight.

10. The gravitational energy conversion device as claimed in claim 2, wherein each of the energy converters has a fixed part which is fixed in the weight and movably connected to the moving part that corresponds to said fixed part.

11. The gravitational energy conversion device as claimed in claim 2, wherein the resilient part of each one of the energy converters is a helical spring, a gas spring, or a magnetic spring.

12. The gravitational energy conversion device as claimed in claim 1, wherein the support surface is a flat surface being horizontal.

13. A gravitational energy conversion system, comprising:
a flat conveyor configured to convey along a conveying direction;
the gravitational energy conversion device as claimed in claim 1, wherein the support surface is an upper surface of the flat conveyor, and a center line of the gravitational energy conversion device is perpendicular to the conveying direction of the flat conveyor;
wherein, when the gravitational energy conversion device rotates on the support surface, the flat conveyor is capable of conveying the gravitational energy conversion device along the conveying direction to keep a position of the gravitational energy conversion device on the flat conveyor.

14. A gravitational energy conversion system, comprising:
a second base;
a support roller; an axle of the support roller fixed to the second base;
the gravitational energy conversion device as claimed in claim 1, wherein the support surface is an outer annular surface of the support roller, and a center line of the gravitational energy conversion device is parallel to the axle of the support roller.
